(19) United States
(12) Patent Application Publication
(10) Pub. No.: US 2013/0144783 A1
(43) Pub. Date: Jun. 6, 2013

(54) SYSTEM AND METHOD FOR A SUPPLIER TO SUPPLIER PAYMENT SYSTEM TO PROCESS A TRANSACTION

(71) Applicant: American Express Travel Related Services Company, Inc., New York, NY (US)

(72) Inventor: Fred Bishop, Glendale, AZ (US)

(73) Assignee: American Express Travel Related Services Company, Inc., New York, NY (US)

(21) Appl. No.: 13/736,215

(22) Filed: Jan. 8, 2013

Related U.S. Application Data
(63) Continuation-in-part of application No. 13/327,282, filed on Dec. 15, 2011.
Application No. 13/327,282 is a continuation of application No. 13/020,576, filed on Feb. 3, 2011.
Application No. 13/020,576 is a continuation of application No. 10/728,279, filed on Dec. 4, 2003, now Pat. No. 7,908,215.
Application No. 10/728,279 is a continuation-in-part of application No. 10/611,034, filed on Jun. 30, 2003.

(51) Int. Cl. G06Q 20/22

(52) U.S. Cl. CPC G06Q 20/223
USPC 705/42; 705/39

(57) ABSTRACT

Dynamically enabling and facilitating supplier to supplier facilitated customer transactions. A prepaid value account is issued to a customer by a first supplier for use at participating suppliers. A customer interacts with a second supplier of an item (e.g., goods or services), selects an item for purchase, and provides the supplier with payment criteria associated with the prepaid value account. The supplier interacts directly with the payment systems holding the prepaid value to partially or fully process payment for the transaction.

### REFERENCE TO RELATED APPLICATION

This application is a continuation-in-part of, claims priority to and the benefit of, U.S. Ser. No. 13/327,282 filed on Dec. 15, 2011 and entitled “SYSTEM AND METHOD FOR SELECTION OF PAYMENT SYSTEMS FROM A PAYMENT SYSTEM DIRECTORY TO PROCESS A TRANSACTION.” The '282 application is a continuation of claims priority to and the benefit of, U.S. Pat. No. 8,090,655 issued on Jan. 3, 2012 (aka U.S. Ser. No. 13/020,579 filed on Feb. 3, 2011) and entitled “SYSTEM AND METHOD FOR SELECTION OF PAYMENT SYSTEMS FROM A PAYMENT SYSTEM DIRECTORY TO PROCESS A TRANSACTION.” The '655 patent is a continuation of, claims priority to and the benefit of, U.S. Pat. No. 7,908,215 issued on Mar. 15, 2011 (aka U.S. Ser. No. 10/728,279 filed on Dec. 4, 2003) and entitled “SYSTEM AND METHOD FOR SELECTION OF PAYMENT SYSTEMS FROM A PAYMENT SYSTEM DIRECTORY TO PROCESS A TRANSACTION.” The '215 patent is a continuation-in-part of, claims priority to and the benefit of, U.S. patent application Ser. No. 10/611,034, entitled “System and Method for a Payment System Directory,” and filed Jun. 30, 2003. All of which are incorporated herein by reference for any reason.

### FIELD OF DISCLOSURE

The present disclosure generally relates to the use of payment systems to process payments, and more particularly, to a system and method for facilitating supplier to supplier enabled customer transactions via a prepaid value account issued to a customer by a first supplier for use at participating suppliers.

### BACKGROUND

Currently, a supplier routes payment card transactions through an acquiring bank, with which it has an established business relationship. The acquiring bank then utilizes an established financial network (e.g., VisaNet, BankNet) to route the transaction data to the card issuing bank. The supplier does not typically communicate directly with the issuing bank; rather, the established financial networks route transactions to issuing banks based on BIN range, without consideration of other request attributes. A need exists for a system which allows entities more flexibility without the confines that established financial networks use to facilitate processing payments that require participating acquiring banks and issuing banks. A need further exists for non-banked customers to consummate transactions.

### SUMMARY OF THE DISCLOSURE

These above disclosed needs are successfully met via the disclosed system and method. For instance, the present disclosure facilitates transactions within a supplier to supplier payment system. In various embodiments, non-banked customers are able to participate in transaction account backed transactions using the presently disclosed system. Non-banked customers are just one use case. For instance, merchants may transact business directly with each other and/or can support any customer. For example, the present system allows a customer to deposit money with a merchant or receive “store credit” from one merchant that is acceptable at many merchants. This is in contrast with conventional stored value cards which are associated with a bank which underwrites the stored value. In limited cases, conventional stored value cards may be part of a closed system (e.g. used by large box stores, wherein the stored value card is used at a particular store and/or chain of stores underwritten by that store).

According to various embodiments, a customer may deposit funds or receive credit (e.g., very similar to store credit) at a first merchant. A financial account (either virtual for interne usage or an instrument (e.g., card, fob, etc), phone widget, mobile application, etc. may be issued by the first merchant (and/or a third party) to the customer. The customer may then, at a second merchant, initiate a transaction. The second merchant may use a characteristic of the issued financial account to locate the first merchant (such as via IP address, DNS, and/or gateway). The first merchant may verify that the customer has the funds on deposit. In response to the verification, a communication is transmitted to the second merchant and a service and/or product may be delivered to the customer.

To settle, the first merchant may transfer funds (ACH, Direct Debit, etc.) to the account of the second merchant, and/or to an account of a participating third merchant. For instance, a third merchant may hold a stored value amount for the second merchant to make purchases in the same manner disclosed herein. According to various embodiments, participating merchants may wait for some time period (day, week, month, etc.) and net out the money transfers and then settle up for the net by ACH, etc.

According to various embodiments, if the first merchant is big enough, the first merchant could hold a stored value account for the second merchant and the customer and the first merchant adjusts the second merchant's account, such as for the second merchant to make their own purchases at the first merchant. In this case, the first merchant continues to hold the stored value and has, in effect, just changed the customer owning the account. If the funds move out of the first merchant (e.g., if the second merchant moves the funds to a third merchant where first merchant has a stored value account), there may be money movement, at some point, through the banking system between the first merchant and the third merchant.

Thus, in practice, a customer can walk into (or via the interact connect with) any participating merchant's store, open an account by making a deposit, and he issued a financial account that they Can use at any participating merchant. The customer can remain unbanked, or without credit, and the merchants avoid fees.

In various embodiments, a method comprises querying (by a computer based system for identifying a first supplier to second supplier payment system for facilitating processing of a transaction) a directory of payment systems to locate a payment system to process the transaction based at least in part upon payment criteria, wherein the querying is not performed by an acquiring bank. Note references to “first suppliers” throughout this disclosure may be interpreted as “second suppliers” and vice versa. The phrase “querying is not performed” may not involve a third party processor. For instance, the system locates the merchant that is holding the credit/stored value position. Stated another way, the system may include one or more peer networks of merchants and locating the merchant that has the stored value. In contrast to conventional systems, the present system may utilize a directory to find the merchant, and not go through the acquirer and/or issuer to determine if the purchase should be allowed. Aside from potentially an initial funding by a customer, a first merchant may move funds between other merchants, regardless of (or without having to) settling with a bank account every time by moving money from one stored value account to another. The method further comprises receiving (by the computer based system) an identification of the located payment system and transmitting (by the computer based system) the identification of the located payment system to facilitate processing the transaction.

The method may further comprise reconciling the transaction regardless of or without use of a payment system and/or a traditional payment processor. While reconciling is usually completed on an individual transaction level from one merchant hank to another merchant bank, it is contemplated in the present system that merchant banks may he provided none or little information associated with the individual transactions during settlement. In fact, the merchant banks may not “know” the settlement is associated with any transaction at all. Thus, merchant banks may not be fully or partially participating in the system, except when suppliers move money to a bank account, either per transaction, or netting out at the end of the day. Suppliers are able to hold and transfer stored value funds between each other (albeit through the banking system). According to various embodiments, todays supplier is tomorrows customer.

The system may locate the merchant with the stored value through a network and/or electronic directory. For instance, a customer may present an account at a. suppler (supplier 2), the supplier 2 may use the directory to find supplier 1, and see if there is enough on deposit for the purchase. A transaction account issuer may provide the directory service for a fee; however, the suppliers (e.g. supplier 1 and supplier 2) may communicate directly over the internet. A transaction account issuer may also he a stored value provider, and the transactions of the system bypass the conventional transaction account issuer/payment processor payment system directory network and are transmitted directly over the internet, such as via an API.

### BRIEF DESCRIPTION OF THE DRAWINGS

The accompanying drawings, wherein like reference numerals represent like elements, are incorporated in and constitute a part of this specification and, together with the description, explain the advantages and principles of the disclosure. In the drawings,

FIG. 1 is a schematic diagram illustrating an exemplary system and method for dynamically locating and interacting with payment systems to process requests for purchase of item according to various embodiments;

FIG. 2 is a schematic diagram of an exemplary system for processing requests for the purchase of an item according to various embodiments;

FIG. 3 is a schematic diagram of exemplary components of computers used in the system according to various embodiments; and

FIGS. 4 and 5 are flow charts of an exemplary method and system to process requests for purchase of an item according to various embodiments.

### DETAILED DESCRIPTION

The detailed description of various embodiments herein makes reference to the accompanying drawings and pictures, which show the exemplary embodiment by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

Embodiments consistent with the present disclosure enable and facilitate individuals, businesses or other entities to facilitate transactions without the use of acquiring banks, issuing banks and/or traditional payment networks. In various embodiments, a traditional payment network is not utilized to facilitate the transaction. For instance, in various embodiments, a third party independent payment network associated with issuing or acquiring banks is not associated with the exchange of value as part of a transaction. Additionally, an acquiring bank, issuing bank and/or an independent underwriter may not be part of this system and/or involved with the authorization of a transaction. Also, in various embodiments, a third party independent issuing bank is not a participant nor is a third party independent issuing hank associated with the exchange of value as part of a transaction. In the present system, at least a first merchant/supplier and a second merchant/supplier form a merchant payment system, to which they may be participants. This merchant to merchant or supplier to supplier payment network may exist outside of or in concert with traditional independent payment networks. Various embodiments consistent with the present disclosure also enable and facilitate individuals, businesses or other entities to facilitate transactions using a traditional payment network to locate supplier issued stored value account information. According to various embodiments, a transaction may be partially funded through a combination of a traditional payment network and the supplier payment system, such as if the customer has insufficient funds on deposit within the supplier payment system.

In various embodiments, a first supplier 13 may issue a transaction account, such as a stored value account (and/or an off-network account) to an individual/customer 12. This transaction account and/or stored value account may be issued in any suitable medium or form factor. For instance, the stored value may be issued in a transaction instrument such as a card (e.g., smart card), or on electronic storage medium, for instance residing in a memory accessible by a computing device such as a mobile device, smart phone and/or computer. Additionally, the transaction account and/or stored value, credit and/or store credit account may be issued in exchange for any suitable value exchange. For instance, the transaction account may be issued in exchange for cash, credit, charge, debit, clearing house (ACH) and/or wire transfer, trade of goods, promise to pay, barter, non currency trade, other stored value, such as pre-paid cell phone minutes, and/or the like.

The supplier 13 may issue the transaction account to the first customer 12 based at least one of the customer's 12 perceived ability to pay a balance on the card, collateral, pre funding of the account, a recommendation by another customer or supplier, a second customer vouching for the first customer, credit check, job tenure, job history, outstanding debts, income streams, salary, reputation and/or the like.

This transaction account and/or stored value account may comprise (have stored and/or digitally embedded instructions, such as via a fob) instructions for locating and accessing the merchant payment system. The merchant also might pre-register the location of their merchant payment system, so that it is in a widget or part of the information associated with the transaction account/instrument (e.g., a mobile phone or plastic card (e.g. DNS name or IP address) may automatically connect with and/or be directed to the merchant payment system). A supplier may be a merchant. A merchant may be a supplier. For instance, to effect a direct merchant to merchant communication, in response to the merchant with the stored value being located. In various embodiments, this information for locating and/or accessing the merchant payment system may be via at least one of an IP address, DNS directory information, merchant identification number (similar to an issuer identification number), DNS server address, domain, routing information and/or the like.

A first supplier (i.e. holding stored value) may also provide a second supplier (i.e. providing service) with payment criteria, The term payment criteria includes any factors or information relating to payment for goods or services including, for example, the customer's rights through a payment system (including a return policy); discounts, transaction fees; a currency exchange rate; a supplier identity; a user identity; a strength of an authentication method for the user. These following items may be provided by the supplier providing the service and to the supplier with the store value account, wherein the items may be used for determining if the purchase should proceed: an amount of the purchase; a type of item being purchased; a delivery channel for the item; a supplier risk tolerance; taxes related to payment of the item; and/or fees associated with payment of the item.

In various embodiments, the supplier 14 may use details provided by the customer 12 to locate the merchant payment system for the transaction. The supplier 14 then interacts (via a network connection) with the merchant payment system to partially or fully process a payment for the transaction. As used herein, a customer or supplier may include any individual, group, business, entity, software, hardware and/or the like.

In various embodiments, a customer 12 interacts with a supplier 14 of an item, selects an item for purchase, and provides the supplier 14 with payment criteria. The supplier 14 may interact with an optional gateway service to partially or fully process a payment for the transaction. This gateway service may he used to simplify finding the merchant (supplier 13) to validate that the stored value funding is adequate for the transaction. According to various embodiments, many merchants may participate in the system and the gateway would be the mechanism for locating the merchant (supplier 13) with the stored value account, for instance, as an alternative to a DNS providing an IP address for the merchant.

According to various embodiments, transactions could be transmitted through/to the gateway, supplying the merchant number, and the gateway could forward the transaction details to the supplier with the stored value account, and then provide the response to the supplier providing the service. As disclosed herein, according to various embodiments, the payment account/instrument may comprise data for contacting/interfacing with the supplier with the stored value, such as via an IP address, a merchant id (for use with the gateway), a Domain name to look up on a DNS server, a DNS server and Domain name and/or a certificate to sign the transaction. For instance, the certificate to sign the transaction may be used to convey to the supplier with the stored value account that the transaction has some level of trust/verification. The gateway service queries a merchant payment system to locate the appropriate merchant payment system and then interacts with the located merchant payment system to process the payment for the transaction, account settlement and/or authorize a transaction.

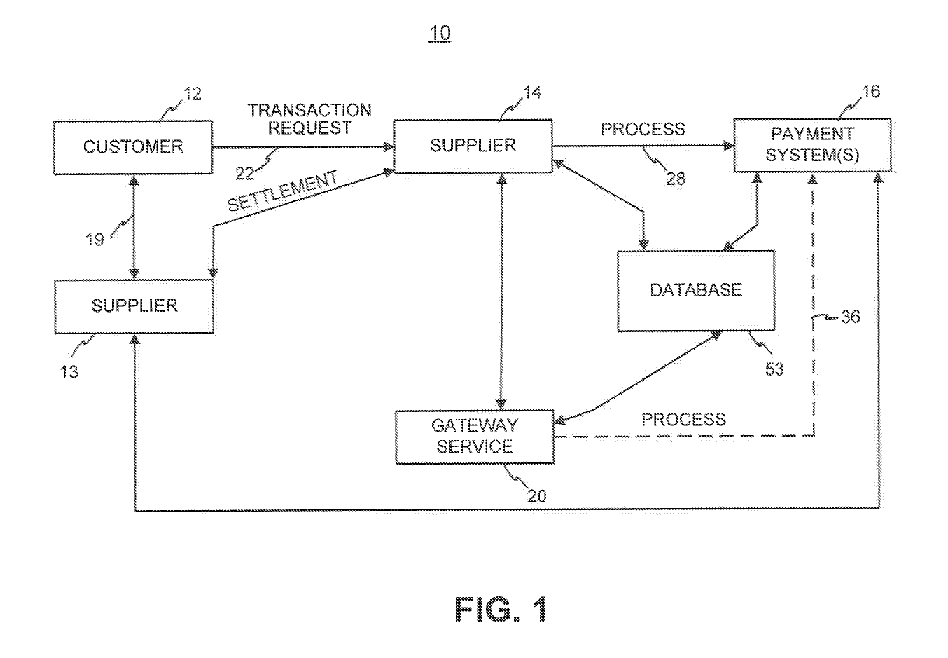

FIG. 1 is a diagram illustrating an exemplary system 10 for implementing embodiments to facilitate supplier 13 to supplier 14 system transactions. In this system 10, a customer 12 may first establish a transaction account, such as stored value transaction account, with a first supplier 13 (19). This supplier 13 will issue the customer 12 a transaction instrument associated with the transaction account to facilitate transactions with the supplier 13 and other participating suppliers 14. In various embodiments, the supplier 13 may store authenticated logon and password information provided from the customer 12 and provide information to access the account such as internet address information to the customer in lieu of and/or in addition to issuing a transaction instrument. The other participating suppliers 14 may have an existing agreement with supplier 13 to accept the stored value transaction account as payment for transaction or the other participating suppliers 14 may commit to an “on-the-fly” contract with supplier 13 to accept the stored value transaction account as payment for transaction in concert with the transaction.

In various embodiments, with reference to FIG. 1, via system 10, a customer 12 transmits a transaction request with payment criteria (22) to a supplier 14 to request purchase of an item. The request may include, for example, an identification of the desired item, and information identifying the customer 12. Supplier 14 is configured to query a merchant payment system to identify the merchant payment system that holds the stored value balance. A transaction may be processed using a plurality of supplier payment systems, such as if the customer holds deposit accounts with a plurality of suppliers.

Because as supplier 14 may not have an existing business relationship with the merchant payment system located by the payment system directory as holding the value of the stored value, it may be desirable for the supplier to enter into an “on-the-fly” contract with the merchant payment system to facilitate financial settlement. In some cases, the merchant payment system may request that the supplier maintain funds in an escrow account to cover potential chargebacks resulting from customer disputes. A supplier who negotiates a contract on-the-fly may also opt to designate the agreement as being in force for all transactions from that date forward, or until additional custom rules are defined, or another contract is established through other channels. In addition, a supplier may elect to process initial transactions with a merchant payment system without having a contract and then require a contract after a certain number of transactions and/or transactions totaling a certain threshold.

According to various embodiments, the customer 12 may increase the value of the stored value on the spot, or at a preselected time or interval, by transferring value into their account at any time. This increase of funds and/or value may be advanced by a first merchant 13, a second merchant 14, at a first supplier, other customers, and/or a second supplier (regardless of where a transaction is occurring). This increase of funds and/or request for increase of funds can be accomplished in person or remotely, Additionally, increases in funds may happen without respect to an associated transaction.

In various embodiments, it is contemplated that customers may use pre-paid phone minutes as currency. For example, the stored value account can be funded through minutes, that either are translated into a dollar amount, or the merchant and customer can agree to settle in minutes as the currency and the stored value supplier can transfer minutes to the merchant instead of dollars. The customer can increase the value of the stored value on the spot by transferring minutes into their account, if their account needs more funding or minutes to complete a transaction. The merchant providing the service can accept the payments in minutes and have them deposited in the merchants account as currency after conversion, so they can make purchases of their own in a more normal manner. This bridges minutes to currency for the merchant.

Therefore, payment instruments may include a financial component, a non-financial component, or both. In various embodiments, the transaction instrument may include contact information, such as a URI, IP address, telephone contact number, and/or DNS server address comprising a database 53 record of the transaction account and its value. A supplier may use this information to identify the database 53 and authentication information such as logon and password (PIN) to access a record of a customer account. In various embodiments, the supplier may record (via a username and password) supplier identification information for a record of the transaction parties.

The payment system may not be managed by, for example, an issuing hank, acquiring bank, third-party processor, or payment aggregator. The payment system directory may allow identification on a world-wide basis, serving as a single or reduced point for submitting all payments requests.

In various embodiments, reconciling the transferring of value need not happen at the time of the transaction. Reconciling may happen at any suitable time. For instance, this may he a batch process, at a designated time, such as a time of day or substantially instantaneously with the transaction. Reconciling may include decrementing the value of the stored value account an amount equivalent to the amount needed for transactions with the merchant. Reconciling may include transferring value from a first merchant to a second merchant. In some embodiments, the amount of transferred value is equivalent to the amount needed for transactions with the merchant. In various embodiments, reconciling the transfer of value between a first merchant 13 and a second merchant 14 need not occur through a payment system directory. This reconciling may occur through a separate merchant 13 to merchant 14 process, merchant 13 to merchant's 14 bank, merchant's bank 13 to merchant 14 or merchant's 13 bank to merchant's 14 bank process. For instance, a second merchant 14 may perform an ACH transfer from the second merchant's 14 bank to the first merchant's 13 bank. The transfer can be by any process currently known, such as ACH transfer, Electronic Funds Transfer, Check, eCheck, and/or the like. The merchants may also reconcile using traditional transaction networks, such as American Express®, VisaNet® and the Veriphone® networks. Stated another way, these payment systems may be used for actual money movement when merchants need money to show up in their bank account after-the-fact, such as outside of the initial stored value transaction.

In various embodiments, the second merchant 14 may verify that the (one or more) stored value account has sufficient value to cover the value of the transaction. As stated previously, this verification can be completed via contacting the merchant payment system and/or the payment system holding the stored value or this can be accomplished using a network to contact a database, such as a central database storing the account information of all or a subset of all the participating merchants.

In various embodiments, a first merchant 13 may issue stored value to a first customer 12. The first customer 12, may request a transaction with the second merchant 14. The second merchant 14 may issue stored value to a second customer 11. The second customer 11, may request a transaction with the first merchant 13. An accounting of the various transactions may be kept. The first merchant 13 need not transfer value from/to the second merchant 14 in response to each transaction. The participating merchants may opt to wait until a pre-established time to reconcile. The participating merchants may reconcile periodically. The accounting will be evaluated at a point in time and the value transferred may occur in response to the total outstanding accounting determination. Thus, the transactions performed with the first merchant or the second merchant may offset the amount of value to be transferred between merchants. Thus, the stored value credits being used by the (one or more) customers between the participating merchants may be a marker that decrements or increases the amount to settle between the participating merchants at a later time. This process may occur outside of a traditional payment network. For instance, a service merchant may transmit a deposit only bank account to facilitate the money movement during the transaction, such as transferring money directly to their accounts though ACH. For instance, in operation, when the stored value merchant approves, they would essentially communicate approval of the giving the customer the service for $100 via the service merchant, and the obligation to transfer $100 to the bank account associated with the service provider merchant.

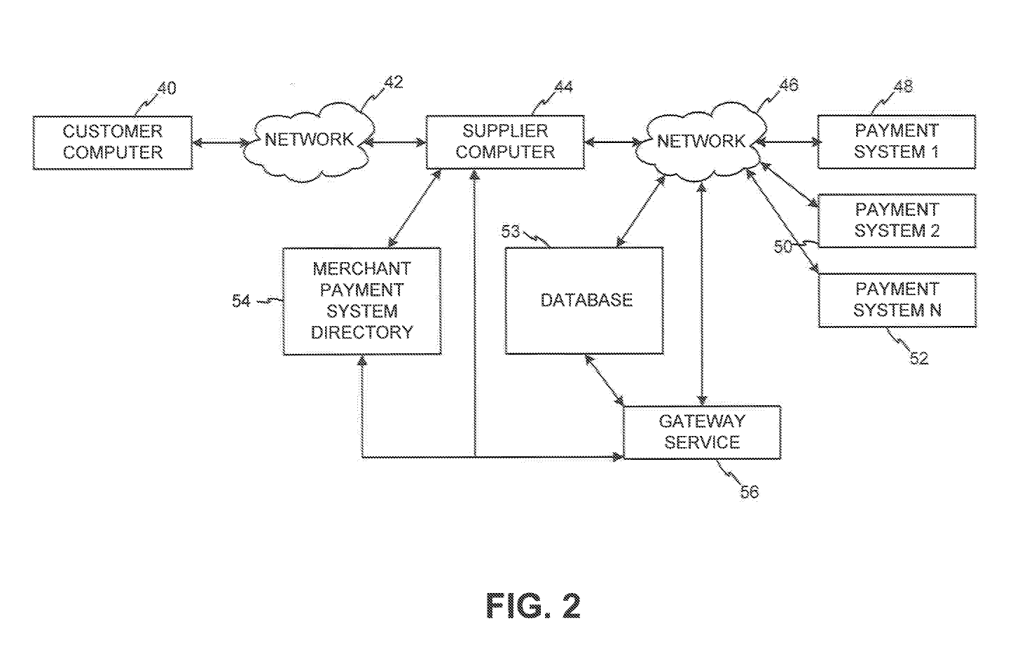

FIG. 2 is a schematic diagram of a system which facilitates processing requests for the purchase of an item in accordance with various embodiments. A customer computer 40 may interact with a supplier computer 44 via a network 42, which may include any type of wireline or wireless network for data communication. Supplier computer 44 may contact a database 53 and/or a merchant payment system directory 54, located either locally or remotely. The database 53 may comprise data to verify the authenticity of the user and/or verify the stored value account has sufficient value to complete the transaction. In response to verification and/or authorization the supplier computer 44 may request that the database 53 data be updated to reflect the details of the transaction.

Three payment systems and one database are shown for illustrative purposes only, and other systems may use more or fewer payment systems and/or databases.

In various embodiments, supplier computer 44, via network 46, may transmit information for the transaction to a gateway service 56, which may then process the transaction by querying payment system directory database 54 and communicating with the appropriate payment systems and/or database 53. The gateway service 56 may also be implemented with, for example, a programmed computer. The computers shown may communicate with each other via the networks using, for example, Internet Protocol addresses or other methods of locating an entity via a communications network.

In various embodiments, supplier computer 44, via network 46, may transmit information for the transaction to a gateway service 56, which may then process the transaction by contacting database 53. The gateway service 56 may also be implemented with, for example, a programmed computer. The computers shown may communicate with each other via the networks using, for example, Internet Protocol addresses or other methods of locating an entity via a communications network.

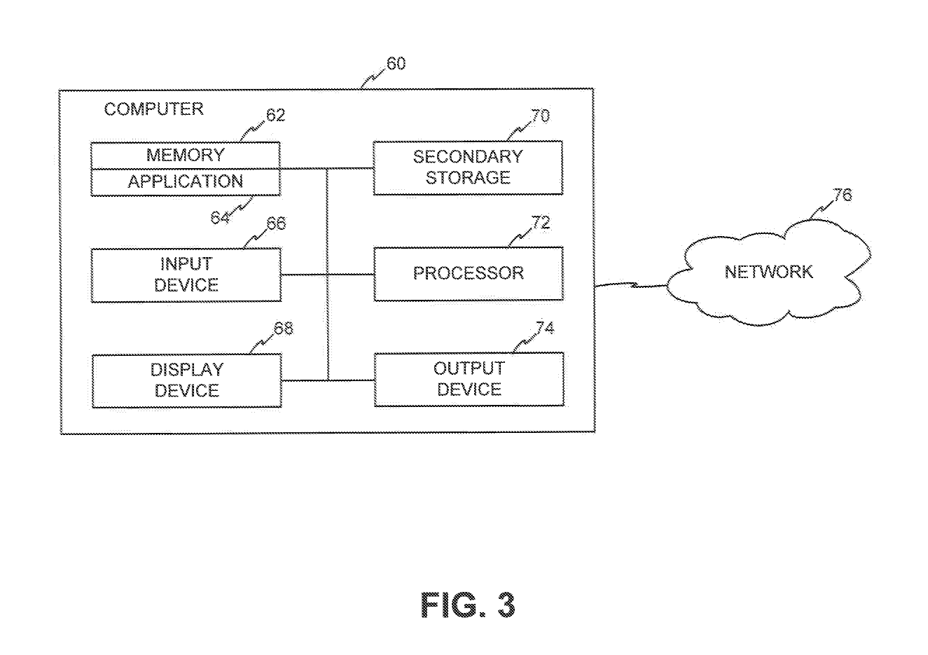

FIG. 3 is a schematic diagram of an exemplary computer 60 illustrating typical components of the computers shown in FIG. 2 for the system. Computer 60 may include a connection with a network 76 as the Internet or communications networks through any suitable network connection. Computer 60 typically includes a storage memory 62, a secondary storage device 70, a processor 72, an input device 66 for entering information into computer 60, a display device 68 for providing a visual display of information, and an output device 74 for outputting information such as in hard copy or audio form.

Memory 62 may include random access memory (RAM) or similar types of memory, and it may store one or more applications 64 for execution by processor 72. Applications 64 may include programming to perform the methods discussed herein such as, for example, dynamically locating and using payment systems.

Secondary storage device 70 may include any hardware and/or software for storing data such as, for example, a hard disk drive, floppy disk drive, CD-ROM drive, or other types of non-volatile data storage. Processor 72 may execute applications or programs stored in memory 62 or secondary storage 70, or received from the Internet or other network 76. Although computer 60 is depicted with various components, one skilled in the art will appreciate that the computer may contain different components. Computer 60 may include local or remote databases for storing and retrieving information for processing transactions, including payment system directory database 54 and/or database 53.

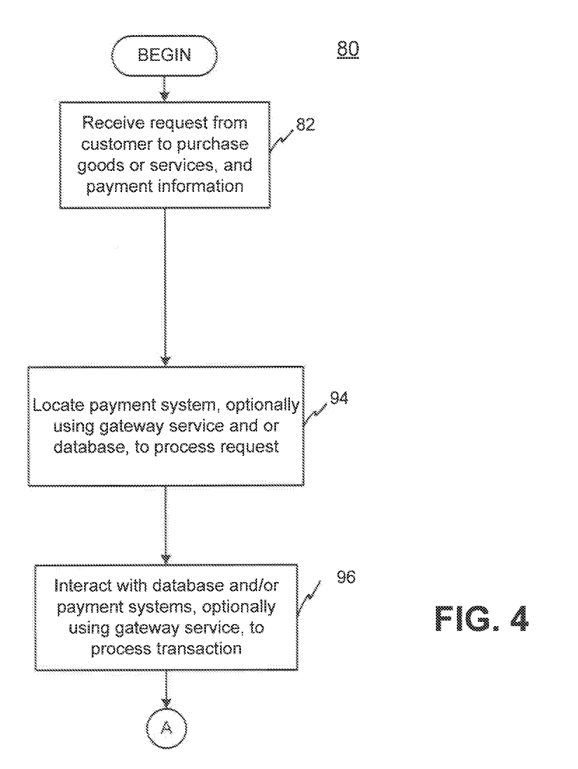

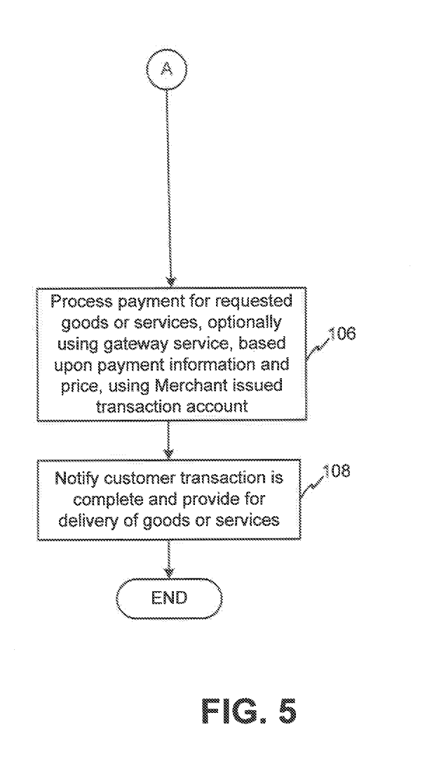

FIGS. 4 and 5 disclose flow charts of an exemplary method 80 to facilitate processing requests for purchase of an item via a supplier to supplier network. Method 80 may be implemented in, for example, software modules for execution by supplier computer 44, gateway service 56, database 53 and/or payment systems 48, 50, and 52. Although the steps of method 80 are shown in a particular order, they may alternatively be executed in other orders and more steps may be added or steps removed, if necessary or desired.

In method 80, a customer is issued a transaction account such as a stored value account from the supplier. in various embodiments, no issuing bank is involved with the issuance of the transaction account. A second supplier receives a request from the customer, such as via network 42, at customer computer 40 and/or directly at supplier computer 44, to purchase an item along with payment criteria (step 82). The request can potentially include user preferences for use in locating one or more payment systems and/or databases to interact with and process the request. Also, the request may be in any particular format for network transmission and sent according to any suitable protocol. The request may be sent, for example, via a web page, or other on-line or network communication.

Supplier computer 44 may authenticate the customer identity at various points in the processing of method 80 or as part of the payment criteria. The authentication may use, for example, any particular authentication methods, to help prevent fraudulent transactions. The supplier identity may also be authenticated in various embodiments.

Supplier computer 44 may determine whether to use gateway service 56 and, if so, it may transmit information related to the request to gateway service 56. An advantage of using the gateway service includes, for example, not necessarily requiring that the supplier know the locations and protocols of all the merchant payment systems. Supplier computer 44, may locate the merchant payment system for processing the transaction (step 94).

Supplier computer 44, or gateway service 56, interacts with the identified payment system(s) and/or databases to process the transaction (step 96). Supplier computer 44, or gateway service 56, may processes payment for the requested item based upon the payment criteria and price, using the furnished transaction account, such as the supplier issued prepaid account (step 106). The transaction may include a financial component, a non-financial component, or both. The transaction may include multiple suppliers of issued prepaid accounts. The payment processing may also utilize conventional systems and financial networks to obtain payment from the customer in addition to supplier issued transaction accounts. When the customer signs up, the merchant selling the stored value will set the terms and conditions.

The present system works well in a shared marketplace, where a customer could deposit money at the door and then purchase at many merchants, as well on the Internet and with programmable POS devices. According to various embodiments, merchants may act as a collection of merchants in that they share a single stored value account across a number of merchants, the effect being as if the purchase was made at the same store as holding the stored value, even though they might really be different merchants. This would have the effect of the stored value supplier just keeping ledgers of every participating merchant's position, and then settling up periodically and/or as needed.

The system may notify the supplier and the customer that the transaction is complete once processing is finished or any other status update during the process, and arrange for delivery of the purchased item to the customer (step 108). The supplier may notify the customer. Alternatively, the notification may be sent from a merchant providing the item to the customer, and such notification can be provided by, for example, an e-mail, letter, or phone call.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

In various embodiments, the server may include application servers (e.g. WEB SPHERE, WEB LOGIC, JBOSS). In various embodiments, the server may include web servers (e.g. APACHE, HS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network, A web-client may run Microsoft Internet Explorer, Mozilla Firefox, Google Chrome, Apple Safari, or any other of the myriad software packages available for browsing the interne.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including hap, https, ftp, and sftp.

In various embodiments, components, modules, and/or engines of the presently disclosed systems may be implemented as micro-applications or micro-apps, Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e,g, IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAJK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT FIELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein,

“Cloud” or “Cloud computing” includes a model for enabling convenient, on-demand network access to a shared pool of configurable computing resources (e,g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

As used herein, “issue a debit”, “debit” or “debiting” refers to either causing the debiting of a stored value or prepaid card-type financial account, or causing the charging of a credit or charge card-type financial account, as applicable. Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like, Phrases and terms such as “supplier to supplier”, in various embodiments, do not involve an issuing and/or acquiring bank.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Carnal, Schorr signature, DSA, PGP, PKI, and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system, in one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, cheek boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C. C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “consumer”, “customer”, “cardmember”, “business” or “merchant” may be used interchangeably with each other, and each shall mean any person, entity, government organization, business, machine, hardware, and/or software,. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the supplier computer may be interconnected via a second network, referred to as a payment network. The payment network which may be part of certain transactions represents existing proprietary networks that presently accommodate transactions for credit cards, debit cards, and other types of transaction accounts. These payment network may be a closed network that is assumed to be secure from eavesdroppers.

The electronic commerce system may be implemented at the customer and supplier computer. In an exemplary implementation, the electronic commerce system is implemented as computer software modules loaded onto the customer computer and the supplier computer. The merchant computer does not require any additional software (other than a browser) to participate in the online commerce transactions supported by the online commerce system.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 2-5 the process flows and screenshots depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-5, but also to the various system components as described above with reference to FIG. 1.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions, Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not Dryly propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account. Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The phrases account holder, participant or cardmember shall include any person, entity, government organization, business, machine associated with a transaction account, regardless of whether a physical card is associated with the account. For example, the cardmember may include a transaction account owner, an transaction account user, an account affiliate, a child account user, a subsidiary account user, a beneficiary of an account, a custodian of an account, and/or any other person or entity affiliated or associated with a transaction account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http:/www.emvco.com/default.aspx

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction. Phrases and terms similar to “business” or “supplier” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument. Phrases and terms similar to “merchant,” “supplier” or “seller” may include any entity that receives payment or other consideration, For example, a supplier may request payment for goods sold to a buyer who holds an account with a second supplier, Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

1. A method, comprising:
receiving, by a computer based system for facilitating processing of supplier payment system transactions and via a second supplier, a request for a transaction and a first supplier issued transaction account for payment;
locating, by the computer based system, a payment system associated with the first supplier issued transaction account;
querying, by the computer based system, the located payment system for a determination of sufficient funds;
receiving, by the computer based system, determination of sufficient funds; and
processing, by the computer based system, the transaction based on an affirmative response to the determination of sufficient funds, wherein the transaction is processed without interacting with an issuing or an acquiring bank.

2. The method of claim 1, wherein the locating is performed by the second supplier system.

3. The method of claim 1, further comprising receiving a first supplier issued transaction instrument; wherein the transaction instrument is issued by the first supplier without an issuing or an acquiring bank.

4. The method of claim 3, wherein the transaction instrument is at least one of a virtual transaction instrument, a card, and mobile computing device application.

5. The method of claim 1, wherein a customer receives value at the first supplier for use at participating suppliers in the supplier payment system based on a deposit.

6. The method of claim 5, wherein value is issued in exchange for at least one of cash, credit, charge, debit, clearing house or wire transfer, trade of goods, promise to pay, barter, and non-currency trade.

7. The method of claim 5, wherein value is issued in exchange for at least one of the purchase of cell phone minutes and cell phone minutes.

8. The method of claim 1, further comprising transmitting, by the computer based system, transaction details to a database for reconciliation.

9. The method of claim 1, further comprising authenticating, by the computer based system, an identification of a customer associated with the transaction.

10. The method of claim 1, further comprising reconciling the transaction between the first supplier and the second supplier without use of a payment system.

11. The method of claim 10, further comprising reconciling an aggregation of transactions on a periodic basis to reduce at least one of a value of a settlement between suppliers or a number of settlements between suppliers.

12. The method of claim 10, wherein reconciling comprises settlement between members of the supplier payment system.

13. The method of claim 1, wherein the first supplier issues the transaction account to a customer for use in the transaction, regardless of involvement of the issuing bank.

14. The method of claim 1, wherein the first supplier holds a stored value account for the second supplier.

15. The method of claim 1, wherein the transaction is partially funded through a combination of a traditional payment network and the supplier payment system.

16. The method of claim 1, wherein the transaction is funded through a combination of supplier issued transaction accounts.

17. The method of claim 1, wherein reconciliation comprises settlement between a combination of supplier issued transaction accounts.

18. The method of claim 1, wherein funds may be added to the second supplier issued transaction account by the first supplier.

19. A system comprising:
a second supplier communication device configured to transmit a request for a transaction;
a first supplier issued transaction account for payment;
a payment system associated with the first supplier issued transaction account,
wherein the request comprises locating a payment system associated with the first supplier issued transaction account, and wherein the request comprises querying the located payment system for a determination of sufficient funds;
the second supplier communication device configured to receive the determination of sufficient funds; and
the second supplier communication device configured to process the transaction based on an affirmative response to the determination of sufficient funds, wherein the transaction is processed without interacting with an issuing or an acquiring bank.

20. An article of manufacture including a non-transitory, tangible computer readable storage medium having instructions stored thereon that, in response to execution by a computer based system for facilitating processing of supplier payment system transactions, cause the computer-based system to perform operations comprising:
receiving, by the computer based system, via a second supplier, a request for a transaction and a first supplier issued transaction account for payment;
locating, by the computer based system, a payment system associated with the first supplier issued transaction account;
querying, by the computer based system, the located payment system for a determination of sufficient funds;
receiving, by the computer based system, determination of sufficient funds; and processing, by the computer based system, the transaction based on an affirmative response to the determination of sufficient funds, wherein the transaction is processed without interacting with an issuing or an acquiring bank.
